(19) United States
(12) Patent Application Publication
(10) Pub. No.: US 2010/0310856 A1
(43) Pub. Date: Dec. 9, 2010

(54) TRANSPARENT MATERIALS HAVING ENHANCED RESISTANCE TO CRACK GROWTH

(76) Inventor: Stephen W. Freiman, Potomac, MD (US)

Correspondence Address: KONRAD RAYNES & VICTOR, LLP, 315 S. BEVERLY DRIVE, # 210, BEVERLY HILLS, CA, 90212, US

(21) Appl. No.: 12/794,702

(22) Filed: Jun. 4, 2010

Related U.S. Application Data
(60) Provisional application No. 61/184,294, filed on Jun. 4, 2009.

(51) Int. Cl. B32B 18/00; C03B 8/00; B32B 5/16; C03C 3/32; C03C 3/16; C03C 3/14; C03C 3/04

(52) U.S. Cl. 428/325; 65/17.2; 428/323; 428/328; 428/330; 428/331; 501/40; 501/45; 501/49; 501/53

(57) ABSTRACT

Embodiments relate to a transparent body comprising a matrix material and a plurality of non-metal particles positioned in the matrix material. The matrix material may be selected from the group consisting of glass materials, ceramic materials, and semiconductor materials. The non-metal particles may have a mean particle size of no greater than 150 nm. The non-metal particles may be present in the body at a volume fraction of no greater than 3 percent. The non-metal particles may have a composition different than that of the matrix. Other embodiments are described and claimed.

This application claims the benefit of U.S. Provisional Application No. 61/184,294, filed Jun. 4, 2009, entitled “Window Materials Having Enhanced Resistance to Slow Crack Growth”. Applicant hereby incorporates by reference U.S. Provisional Application No. 61/184,294, filed Jun. 4, 2009, in its entirety.

### BACKGROUND

Materials often used as windows, fiber optic cables, transparent electronics, and displays, such as_glasses and single or polycrystalline ceramics, are typically prone to the slow growth of existing flaws when subjected to an applied load in the presence of environments containing a reactive species such as water. This slow growth of existing flaws is commonly known as slow crack growth, environmentally-enhanced crack growth, or subcritical crack growth, and results in a crack growing at applied stresses less than a critical value determined from the fracture toughness (K_{IC}) of the material. The crack can eventually grow to a size sufficient to cause fracture of the window or other device. The loads can be due to external mechanical forces or to other factors such as thermal or electrical induced forces. The water interacts with the strained bonds at the crack tip, causing the crack to grow. When the crack has grown sufficiently to cause the stress intensity factor, K_{I}, to reach a critical size, K_{IC}, otherwise known as the fracture toughness, catastrophic failure ensues. As a result, materials of interest because of their excellent optical properties (for example, fluoride-based glasses), may be difficult or impossible to employ with confidence in applications where even moderate stresses are present.

### BRIEF DESCRIPTION OF THE DRAWINGS

Certain embodiments of the invention are described with reference to the accompanying drawing which, for illustrative purposes, are schematic and not necessarily drawn to scale.

FIG. 1 illustrates a crack velocity versus stress intensity plot illustrating two materials having different slow crack growth susceptibility.

### DETAILED DESCRIPTION

Certain embodiments of the present invention relate to materials, devices, and methods that show enhanced resistance to slow crack growth. Certain embodiments include transparent glasses and transparent ceramics including a relatively small volume percentage of particles therein and methods for their manufacture.

Delayed failure occurs in most glass and ceramic materials due to the growth of preexisting flaws under stress in the presence of moisture. A crack velocity (v) versus stress intensity factor (K_{I}) diagram can be used to describe slow crack growth in accordance with certain embodiments. The crack velocity versus stress intensity diagram may be generated by performing mechanical properties testing as known in the art, for example, using a double torsion beam testing procedure that measures the crack speed as a function of the driving force. The stress intensity factor is a function of the applied stress and the flaw size, and increases as cracks grow larger.

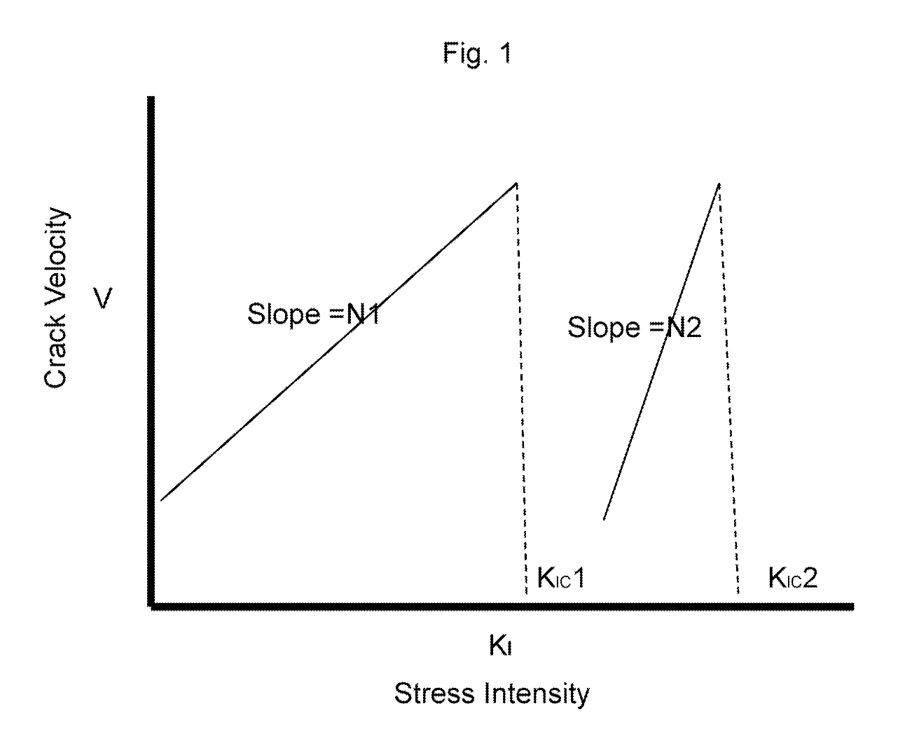

FIG. 1 shows a simplified crack velocity versus (v) versus stress intensity factor (K_{I}) plot for two different materials in the presence of water. The first material has a slope N1 that is less than the slope N2 of the second material. The second material, having the slope N2, corresponds to certain embodiments that are described below. A low value of the slope indicates a low resistance against subcritical crack growth, which means that flaws in the material will grow over a wide range of applied stresses. A high value of the slope means that flaws will grow over a more narrow range of applied stresses. Materials that display a higher slope demonstrate a higher resistance to slow crack growth in the presence of moisture. Thus, the second material will have a greater resistance to slow crack growth than the first material. This in turn leads to a greater lifetime for the second material. In other words, the time to failure for the second material will be significantly larger based on the increased slope.

Certain embodiments include transparent bodies which may be used as windows in various applications. The transparent body may in certain embodiments include a matrix material and a plurality of particles positioned in the matrix material, the particles having a different composition than that of the matrix material. Such embodiments may correspond to the second material having the slope N2 in FIG. 1. The matrix material alone, with no particles therein, may correspond to the first material having the slope N1 in FIG. 1.

Certain embodiments comprise a transparent body including a matrix material and a plurality of particles positioned in the matrix material, the particles having a mean particle size of no greater than 150 nm, and the particles being present at a volume fraction of no greater than about 3 percent. It is possible that the particles provide a stress field when positioned in the matrix material which acts to lower the susceptibility of the body to slow crack growth.

The volume fraction of particles may vary in different embodiments, depending on certain factors such as, for example, the particle size and refractive index of the constituents. In certain embodiments, the volume fraction is no greater than about 2 volume percent. In certain embodiments, a minimum particle volume (for example, 1 weight percent) is needed to achieve the desired effects. Certain embodiments may include between 1 and 3 volume percent particles. Other embodiments may include between 1 and 2 volume percent particles. Still other embodiments may include 2 to 3 volume percent particles.

The particle size may be selected at least in part to minimize or avoid light scattering loses that would decrease the transparency of the body. Certain embodiments may utilize particles having smaller sizes, for example, a mean particle size of no greater than 100 nm. The particles may also be selected to have a relatively close match in refractive index with the matrix material, to again avoid decreasing the transparency of the body. Depending on the specific features of the particles, such as, for example, refractive index and thermal expansion properties, the particle size and/or volume percentage may vary. For instance, the smaller the particle size, the larger the difference in refractive index between the particle and matrix may be acceptable to obtain adequate transparency.

In certain embodiments, the particles are formed from a ceramic material or a glass material. Certain embodiments may be selected from non-metal particles including, but not limited to, oxide, carbide, nitride, and boride particles. Examples of oxide particles include, but are not limited to, aluminum oxide and zirconium oxide. Examples of carbide particles include, but are not limited to, silicon carbide. Examples of nitride particles include, but are not limited to, silicon nitride and aluminum nitride.

The matrix material may in certain embodiments be a transparent material such as a glass, a single crystal ceramic, or a polycrystalline ceramic. Embodiments may also include matrix materials comprising single crystal or polycrystalline semiconductor materials. Examples of matrix materials, include, but are not limited to, oxides, carbides, nitrides, and fluorides. In certain embodiments the matrix is transparent at wavelengths other than the visible, e.g. infrared frequencies.

In one aspect of certain embodiments, the particles are selected so that the transparency of the body is not substantially adversely affected by their presence. If desired, conventional methods for determining the transparency may be used. One method which may be used to determine transparency of a body is to measure the real in-line transmission (RIT), as described in “Transparent Aluminum: A Light-Scattering Model”, by R. Apetz and Michel P. B. van Bruggen, J. Am. Ceram. Soc. 86[33] 480-486 (2003), which is hereby incorporated by reference in its entirety. The RIT may, for example, be measured over an angular aperture of at most 0.5 degrees at a sample thickness of 0.8 mm and with a monochromatic wavelength of light λ (e.g., using a red laser at 645 nm). In certain embodiments, the RIT using the above parameters is expected to be at least 30%.

In addition, in certain embodiments, the slope of a crack velocity versus stress intensity plot for slow crack growth in water for the transparent body including the matrix material and particles therein is substantially greater than that of the matrix material alone. For example, in certain embodiments, the slope is at least 50% greater in the transparent body than for the matrix material alone.

In another aspect of certain embodiments, mechanical properties other than the resistance to slow crack growth are also improved. For instance, in certain embodiments, the presence of the particles leads to a greater fracture toughness (K_{IC}) and greater strength of the transparent body (matrix and particles) when compared to the matrix material alone.

As noted above, a variety of matrix materials including oxide and non-oxide ceramics and glasses may be used in various embodiments. Embodiments may also utilize semiconductor materials. Examples of transparent glasses that may be used include, but are not limited to, fluoride-based glasses, silica-based glasses, phosphate-based glasses, borate-based glasses, nitride-based glasses, and chalcogenide-based glasses. Examples of transparent ceramic matrix materials include aluminum oxide, zirconium oxide, magnesium oxide, magnesium fluoride, and silicon dioxide. Examples of transparent single crystal matrix materials include strontium titanate, titanium dioxide, silicon dioxide, zinc sulfide, and gallium arsenide.

A transparent body may be formed using a variety of processing techniques, including conventional low temperature and higher temperature processing methods.

In one method in accordance with certain embodiments, a glass precursor material is provided, and a plurality of particles are positioned within the precursor material. The precursor material is then heat treated (a heat treatment process may include controlling the heating and cooling of the material) into a transparent body including a glass matrix material having the particles positioned therein. The particles may include properties as discussed above in this application.

In another method in accordance with certain embodiments, a ceramic precursor material is mixed with non-metal particles and heat treated to form a polycrystalline ceramic matrix containing the non-metal particles therein.

In certain embodiments, a sol-gel processing technique may be used. A sol-gel process includes the formation of a colloidal suspension (the sol) from precursors such as silicon or metal alkoxide monomers, and gelation of the sol to form a network in a continuous liquid phase (the gel). The gel is then dried and heat treated to form a glass or ceramic body. In one embodiment non-metal particles are added to the gel prior to the heat treatment. In another embodiment, the non-metal particles may be added to the sol prior to the gel formation.

Certain embodiments also relate to the formation of coatings such as a transparent coating placed onto a device or a portion thereof. Such a coating may be formed to have the same or similar properties to the transparent body embodiments described above, including the matrix and particles therein.

Embodiments may find application in a variety of components, including, but not limited to, devices having a screen, including, but not limited to, computer displays, cellular telephone displays, pda (personal digital assistant) displays, and touch screens. Embodiments may also find application is applications requiring enhanced wear resistance, including, but not limited to, night vision goggles, binoculars, or windows used in harsh environments such as desert conditions. Such components may also include transparent coatings formed on various portions thereof.

It will, of course, be understood that modifications of embodiments of the present invention, in its various aspects, will be apparent to those skilled in the art. Since there may be many modifications without departing from the scope of the invention, the examples set forth herein are not intended to limit the invention but to illustrate certain aspects of the invention more clearly. The scope of the invention should not be limited by the particular embodiments described above. In addition, the terms “including”, “comprising”, “having” and variations thereof mean “including, but not limited to”, unless expressly specified otherwise. A listing of items does not imply that any or all of the items are mutually exclusive, unless expressly specified otherwise. An ordering of operations does not necessarily mean that the operations must be carried out in the listed order. The terms “a”, “an” and “the” mean “one or more”, unless expressly specified otherwise.

What is claimed:

1. A transparent body comprising:
a matrix material:
a plurality of non-metal particles positioned in the matrix material;
the matrix material selected from the group consisting of glass materials, ceramic materials, and semiconductor materials;
the non-metal particles having a mean particle size of no greater than 150 nm;
the non-metal particles being present in the body at a volume fraction of no greater than 3 percent; and
the non-metal particles having a composition different than that of the matrix.

2. The transparent body of claim 1, wherein the ceramic particles have a mean particle size of no greater than 100 nm.

3. The transparent body of claim 1, wherein the matrix material comprises a material selected from the group consisting of oxides, carbides, nitrides, sulfides, and fluorides.

4. The transparent body of claim 1, wherein the matrix material comprises a material selected from the group consisting of a polycrystalline material and a single crystal material.

5. The transparent body of claim 1, wherein the non-metal particles comprise at least one material selected from the group consisting of oxides, carbides, nitrides, and borides.

6. The transparent body of claim 1, wherein the ceramic particles are present in the body at a volume fraction of no greater than 2 percent.

7. The transparent body of claim 1, wherein the matrix material comprises a single crystal selected from the group consisting of strontium titanate, titanium dioxide, silicon dioxide, zinc sulfide, and gallium arsenide.

8. The transparent body of claim 1, wherein the transparent body has a fracture toughness, K_{IC}, greater than that of the matrix material alone.

9. The transparent body of claim 1, wherein the transparent body has a resistance to slow crack growth as measured by the slope of the V-K_{I} curve greater than 2 times that of the matrix material alone.

10. The transparent body of claim 1, wherein the particles are formed from at least one material selected from the group consisting of aluminum oxide, silicon carbide, silicon nitride, and aluminum nitride.

11. The transparent body of claim 1, wherein the matrix material is a glass selected from the group consisting of silicate-based glasses, fluoride-based glasses, phosphate-based glasses, borate-based glasses, nitride-based glasses, and chalcogenide-based glasses.

12. The transparent body of claim 1, wherein the transparent body comprises a screen for an electronic device.

13. The transparent body of claim 1, wherein the transparent body comprises an optical window.

14. The transparent body of claim 1, wherein the transparent body comprises a cover positioned on a device.

15. A transparent coating comprising:
a device;
a matrix material;
a plurality of non-metal particles positioned in the matrix material;
the matrix material selected from the group consisting of glass materials, ceramic materials, and semiconductor materials;
the non-metal particles having a mean particle size of no greater than 150 nm;
the non-metal particles being present in the body at a volume fraction of no greater than 3 percent; and
the non-metal particles having a composition different than that of the matrix;
wherein the matrix material and the plurality of non-metal particles in the matrix material are positioned to coat at least a portion of the device.

16. The transparent coating of claim 15, wherein the non-metal particles consist of glass particles.

17. The transparent coating of claim 15, wherein the non-metal particles consist of ceramic particles.

18. The transparent coating of claim 15, wherein the device is selected from the group consisting of at least one of electronic devices and optical devices.

19. A method of forming a transparent body comprising:
providing a matrix material selected from the group consisting of a glass and a ceramic;
distributing a plurality of non-metal particles in a matrix, the non-metal particles having a different composition than that of the matrix material;
wherein the distributing is controlled so that the volume fraction of the non-metal particles in the matrix is no greater than 3 percent;
wherein the particle size is controlled so that the non-particles have a mean particle size no greater than 150 microns;
wherein the matrix material and particles are selected and processed to form the transparent body.

20. The method of claim 19, wherein the matrix material and particles are processed using a method selected from (i) mixing a glass precursor with non-metal particles and heat treating the glass precursor and particles to form a glass matrix containing the non-metal particles therein; (ii) adding non-metal particles during a sol-gel process to form a matrix containing the non-metal particles therein; and (iii) mixing a polycrystalline ceramic precursor with non-metal particles and heating treating the polycrystalline ceramic precursor and particles to form a polycrystalline ceramic matrix containing the non-metal particles therein.
